(19) United States
(12) Patent Application Publication
(10) Pub. No.: US 2026/0261286 A1
(43) Pub. Date: Sep. 3, 2026

(54) INFORMATION DESIGN AND SIGNALING FOR RECONFIGURABLE INTELLIGENT SURFACE

(71) Applicant: ZTE Corporation, Shenzhen (CN)

(72) Inventors: Mengnan JIAN, Shenzhen (CN); Yijian CHEN, Shenzhen (CN); Guanghui YU, Shenzhen (CN)

(21) Appl. No.: 18/878,355

(22) PCT Filed: Jun. 24, 2022
(86) PCT No.: PCT/CN2022/101239

§ 371 Date: Dec. 23, 2024

(51) Int. Cl. H04B 7/04

(52) U.S. Cl. CPC H04B 7/04013

(57) ABSTRACT

Methods, apparatus, and systems that relate to the design and signaling of type, capability, and other information of one or more Reconfigurable Intelligent Surface (RIS) structures or nodes are disclosed. In one example aspect, a method for wireless communication includes reporting, upon a change in a network, information about a first RIS node to one or more base stations. A reconfigurable intelligent surface comprises a material having an electromagnetic property that is configurable.

### CROSS-REFERENCE TO RELATED DISCLOSURE

This disclosure is a national stage filing under 35 U.S.C. § 371 of international application number PCT/CN2022/101239, filed Jun. 24, 2022, which is incorporated herein by reference in its entirety.

### TECHNICAL FIELD

This disclosure is directed to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This disclosure describes, among other things, techniques related to the design and signaling of type, capability, and other information of one or more Reconfigurable Intelligent Surface (RIS) structures or nodes. A reconfigurable intelligent surface comprises a material having an electromagnetic property that is configurable.

In one example aspect, a method for wireless communication includes reporting, upon a change in a network, information about a first RIS node to one or more base stations.

In another example aspect, a method for wireless communication includes receiving, by a base station, information about a first RIS node upon a change in a network.

In another example aspect, a communication apparatus is disclosed. The apparatus includes a processor that is configured to implement an above-described method.

In yet another example aspect, a computer-program storage medium is disclosed. The computer-program storage medium includes code stored thereon. The code, when executed by a processor, causes the processor to implement a described method.

These, and other, aspects are described in the present document.

### BRIEF DESCRIPTION OF DRAWINGS

FIG. 1A illustrates an example of a reflective RIS in accordance with one or more embodiments of the present technology.

FIG. 1B illustrates an example of a transmitting RIS in accordance with one or more embodiments of the present technology.

FIG. 1C illustrates an example of an RIS-based transmitter in accordance with one or more embodiments of the present technology.

FIG. 1D illustrates an example of simultaneously transmitting and reflecting (STAR) RIS in accordance with one or more embodiments of the present technology.

FIG. 1E illustrates an example of a back-to-back RIS in accordance with one or more embodiments of the present technology.

FIG. 2A illustrates an example of RIS performance information in accordance with one or more embodiments of the present technology.

FIG. 2B illustrates an example of configuration information in accordance with one or more embodiments of the present technology.

FIG. 2C illustrates an example of impedance information in accordance with one or more embodiments of the present technology.

FIG. 2D illustrates an example of location information in accordance with one or more embodiments of the present technology.

FIG. 3 illustrates an example flowchart of reporting RIS frequency capability in accordance with one or more embodiments of the present technology.

FIG. 4 illustrates an example flowchart of reporting time-division capability in accordance with one or more embodiments of the present technology.

FIG. 5 illustrates an example flowchart of reporting phase modulation capability in accordance with one or more embodiments of the present technology.

FIG. 6 illustrates an example flowchart of reporting amplitude modulation capability in accordance with one or more embodiments of the present technology.

FIG. 7A illustrates an example of one RIS structure in communication with a single base station in accordance with one or more embodiments of the present technology.

FIG. 7B illustrates an example of multiple RIS structures in communication with a single base station in accordance with one or more embodiments of the present technology.

FIG. 7C illustrates an example of multiple base stations in communication with a single RIS structure in accordance with one or more embodiments of the present technology.

FIG. 7D illustrates an example of multiple base stations in communication with multiple RIS structures in accordance with one or more embodiments of the present technology.

FIG. 8A is a flowchart representation of a method for wireless communication in accordance with one or more embodiments of the present technology.

FIG. 8B is a flowchart representation of a method for wireless communication in accordance with one or more embodiments of the present technology.

FIG. 9 shows an example of a wireless communication system where techniques in accordance with one or more embodiments of the present technology can be applied.

FIG. 10 is a block diagram representation of a portion of a radio station in accordance with one or more embodiments of the present technology can be applied.

### DETAILED DESCRIPTION

The continuous development of mobile communication technology brings the challenge of scarcity in wireless spectrum resources. Research on how to find innovative, efficient, and energy-efficient solutions for future wireless networks is imperative. Reconfigurable Intelligent Surface (RIS) technology is a revolutionary wireless communication enhancement and an important application of information metamaterials in the field of mobile communication. The basic principle is to control the electromagnetic properties of metamaterials through digital programming so as to artificially control the scattering of space electromagnetic waves, realize intelligent regulation of space electromagnetic waves, and construct an intelligent and controllable electromagnetic environment that has the characteristics of low power consumption and low cost. By building an intelligent and controllable wireless environment, the RIS technology can bring a new communication network paradigm to the future generations of wireless technology.

In traditional communications, the endpoint of the transceiver can be optimized but transmissions on channels depend on the environmental conditions. The introduction of RIS makes the channel controllable, and the transceiver and the channel can be jointly optimized to control the propagation of electromagnetic waves. In particularly, the RIS technology can be significant in solving non-line-of-sight transmission problems, extending coverage, increasing transmission freedom, reducing electromagnetic pollution, super-large-scale terminal access, environmental sensing, and positioning. To provide various functionalities, achieve better environmental control, and low-cost architecture design, many different types of RIS have been designed. However, the design of information exchange of different types of RIS is still in an early stage. Moreover, it remains to be an issue to define the relevant type, capability information, and networking information of RIS and to inform the base station of such information accordingly.

This disclosure discloses techniques that can be implemented in various embodiments for the design and signaling of the RIS types, capability information, and other characteristics of the RIS so as to allow the base station(s) to determine appropriate control information to enable efficient subsequent communication using the RIS.

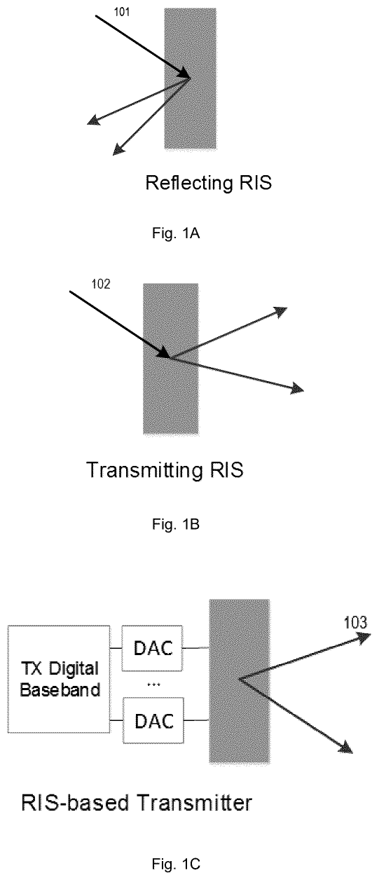

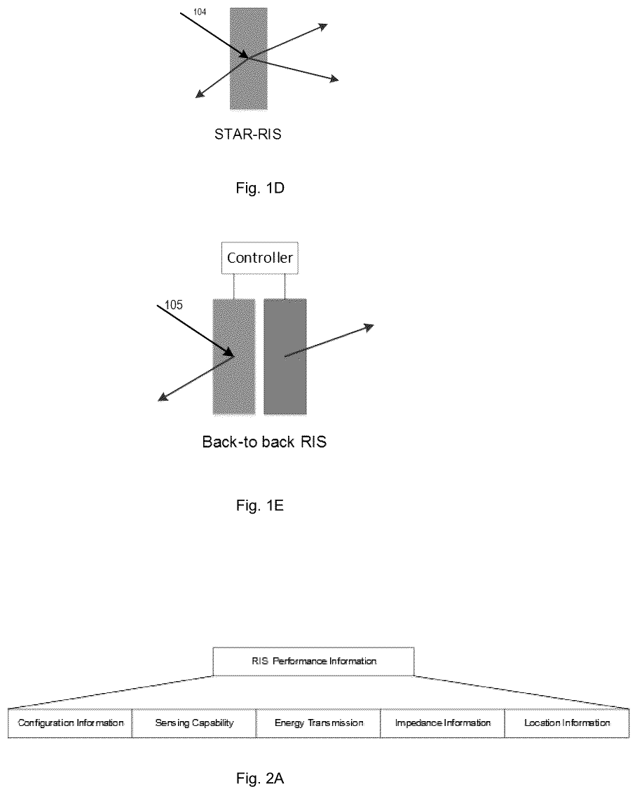

RIS Type Information FIGS. 1A-E illustrate the various RIS types in accordance with one or more embodiments. FIG. 1A illustrates an example of a reflective RIS in accordance with one or more embodiments of the present technology. A reflective RIS refers to a RIS structure with only reflection ability. The signal 101 is incident from one side and exits from the same side, achieving 1800 of coverage on one side of the structure. This type of RIS structure is suitable for deployment in space and can achieve blind spot coverage, coverage expansion, and support for multi-stream transmission through reflected signals.

FIG. 1B illustrates an example of a transmitting RIS in accordance with one or more embodiments of the present technology. A transmitting RIS refers to a RIS structure with only transmitting capability. The signal 102 is incident from one side of the structure and exits from the other side, achieving a 1800 of coverage of the area with both sides of the structure. This type of RIS structure is suitable for deployment in space and generally needs to be deployed on transparent media such as glass surfaces to realize outdoor-to-indoor and indoor-to-outdoor transmissions.

FIG. 1C illustrates an example of an RIS-based transmitter in accordance with one or more embodiments of the present technology. An RIS-based transmitter refers to a connection with the radio frequency structure of a base station (e.g., baseband, Digital to Analog Converter (DAC)) to achieve high-precision transmission signal generation in a low-cost manner. The RIS based transmitter can generate signals 103 to achieve 1800 of transmission signal coverage. This type of RIS is suitable for deployment on the base station and can replace traditional antennas and phase shifters at a lower cost.

FIG. 1D illustrates an example of simultaneously transmitting and reflecting (STAR)-RIS in accordance with one or more embodiments of the present technology. A STAR-RIS represents a RIS with both reflection and transmission capabilities. The signal 104 is incident from one side and can be emitted from both sides respectively to achieve 3600 or omnidirectional coverage. This type of RIS is suitable for deployment in spaces that support both reflection and transmission, such as deploying on window glass to enhance indoor and outdoor signals simultaneously.

FIG. 1E illustrates an example of a back-to-back RIS in accordance with one or more embodiments of the present technology. A back-to-back RIS is an extension of the reflective RIS. That is, two reflective RISs are deployed in a back-to-back manner to allow signal 105 to be incident from one side and be emitted from both sides so as to achieve 3600 of coverage. Some reflective RISs are designed to include an active amplification unit to solve the problem of multiplicative attenuation. This type of RIS structure can be deployed in spaces such as columns and glass to provide coverage and capacity.

In the RIS system design, the elements in the RIS are often times modeled array-based elements. In some embodiments, the array-based elements (e.g., array-based reflectors) are configured to operate independently of each other. When an RIS structure gains access to the network, the RIS can send its identifier (e.g., RIS ID) and the type information to the base station so that the base station can appropriately determine processing algorithms and subsequent signaling exchange for different types of RIS structures deployed in different locations. The information transmitted from different RIS structures can have some common information fields and some dedicated information fields specific to each type. For example, the common information fields can include, but not limited to, information about RIS element composition, quantitative performance, configuration information (e.g., topology, RIS elements, regulation), and so on. The dedicated information field specific each type can include at least the following:

1. Reflective RIS: The reflective RIS generally needs segmented channel state information and/or RIS location information from the base station. When the RIS functions as a relay node, this information can be communication from the RIS to the UE.

2. Transmitting RIS: The transmitting RIS also needs segmented channel state information from base station. When the RIS functions as a relay node, the RIS can communication its capability information and/or location information to the UE.

3. RIS-based transmitter: The RIS-based transmitter needs to obtain the channel state information from the base station.

4. STAR-RIS: The STAR-RIS can report its transmission and reflection capabilities to the base station, including whether the reflection and transmission are controllable and constrained. In some embodiments, the STAR-RIS can also indicate the achievable reflection-transmittance ratio to the base station.

5. Back-to-back RIS: The back-to-back RIS can exchange channel state information for both of the RIS structures. The back-to-back RIS can also inform the base station of the information transmission method between the two RIS, and whether they are equipped with an active power supply unit.

The RIS types as shown in FIGS. 1A-E are determined based on the functionality of the RIS structures. An alternative and/or an additional way to classify RIS structures is based on the energy consumption of the RIS structures. For example, an RIS configured to amplify a signal can be classified as an active RIS while an RIS configured without any signal amplification features is considered as a passive RIS. Similar to the discussion above, such type information can be communicated to the base station(s) accordingly.

The exchange of RIS type information enables the base station to determine control signal phase-shifting matrix for the RIS, thereby taking full advantage of different types of RIS and avoiding waste of network resources.

### RIS Capability Information

RIS capability information can includes various categories of information, including but not limited to: RIS performance information, frequency capability, time division capability, phase modulation capability, amplitude modulation capability, precoding capability, baseband measurement capability, and or reflection and transmission capability. The categories are discussed in detail below.

### Category 1: Performance Information

FIG. 2A illustrates an example of RIS performance information in accordance with one or more embodiments of the present technology. An RIS's performance information can include different sub-categories of information, including but not limited to configuration information, sensing capability, energy transmission information, impedance information, and location information.

In some embodiments, the RIS can inform the base station of its configuration information. FIG. 2B illustrates an example of configuration information in accordance with one or more embodiments of the present technology. The configuration information includes the RIS topology, the type of RIS elements, the number of RIS elements, and the control method(s). The topology of RIS includes square plane, sphere plane, ellipse plane, triangle plane, hexagon plane, square curve, sphere curve, etc. With this information, the base station can determine the type, topology, and size of the RIS, thereby enabling efficient channel estimation and beamforming algorithm design.

In some embodiments, the RIS can inform the base station whether the RIS has sensing ability. If the RIS has sensing ability, the RIS can report information about the sensing accuracy to the base station.

In some embodiments, the RIS can inform the base station whether it has energy transmission capability. If the RIS supports energy transmission capability, the RIS can report is energy transmission energy detection threshold to the base station.

In some embodiments, the RIS can determine the impedance information according to its structure and transmit the information to the base station. FIG. 2C illustrates an example of impedance information in accordance with one or more embodiments of the present technology. For a RIS that has a half-wavelength element spacing, it is often considered that the mutual impedance of a half-wavelength RIS can be ignored. Therefore, the half-wavelength element spacing information can be transmitted to the base station, while the impedance information can be transmitted only when needed. For a RIS whose element spacing is less than half a wavelength, both the element spacing information and the impedance information can be transmitted to the BS. In some embodiments, due to symmetry of the RIS structure, the impedance information can be compressed according to an agreed rule before being transmitted to the base station to reduce signaling overhead. The base station can decompress the information according upon receipt.

In some embodiments, the RIS reports its location information to the base station. If the RIS location is fixed, the RIS only needs to report such information once. FIG. 2D illustrates an example of location information in accordance with one or more embodiments of the present technology. The location information can include the distance with respect to the base station, angle information, and/or information about the surrounding environment. According to the location information, the base station can determine whether the RIS is in the near-field or the far-field of base station and determine the angle between the RIS and the base station. In some embodiments, the RIS can perform measurements of its surroundings to determine environmental information, such as weather information, occlusion information, etc. The environmental information can also be transmitted to the base station.

The exchange of RIS's performance information helps the base station to determine the shape of the RIS, obtain information of the functional capabilities, energy transmission ability, and the impedance information of the RIS to better design the transmission scheme and the RIS phase-shift matrix, and to provide position and angle information to assist signal transmissions. For example, if the RIS is dynamically deployed, the base station can calculate its desired deployment position. The base station can further adjust the position after the RIS notifying its performance information (e.g., configuration information, locational information, etc.). After the adjustment is completed, the RIS can notify the base station of the updated RIS performance information.

### Category 2: Frequency Capability.

RIS can have different amplitude and phase responses to different frequency points. When a new RIS gains access to the network, the base station needs to be informed of the frequency and bandwidth supported by the RIS.

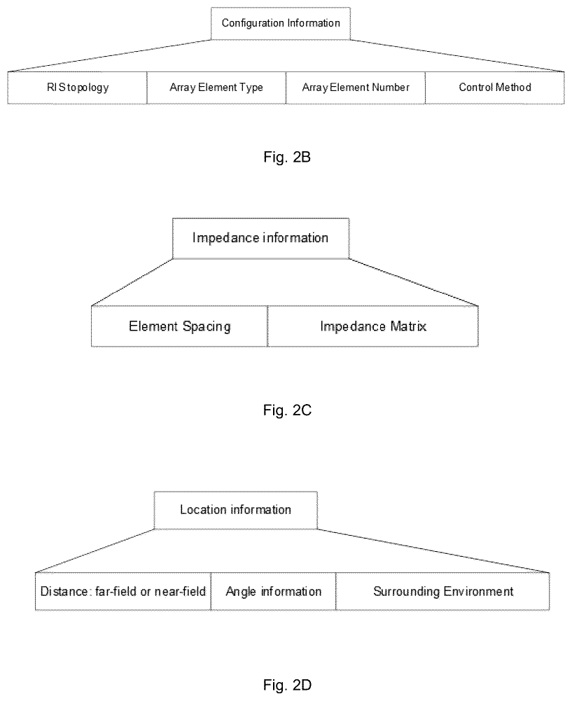

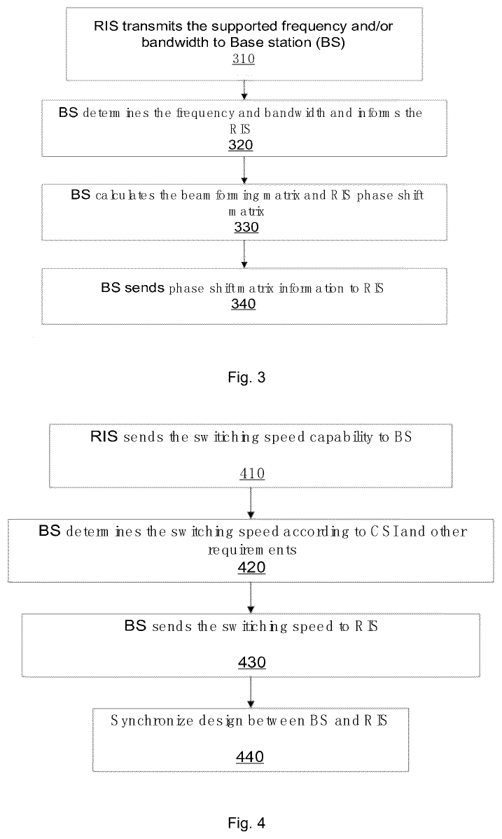

FIG. 3 illustrates an example flowchart 300 of reporting RIS frequency capability in accordance with one or more embodiments of the present technology. The RIS, at operation 310, transmits the supported frequency and/or bandwidth to the base station. The base station then determines, at operation 320, the operating frequency and bandwidth information accordingly and informs the RIS of the operating frequency and bandwidth. At operation 330, the base station calculates the beamforming matrix and RIS phase shift matrix. The base station can send, at operation 340, the phase shift matrix information to RIS.

The base station performs channel state information acquisition and beamforming design for different frequencies and bandwidths. The acquisition of RIS frequency capability can provide frequency-related information and avoid mismatch of system design that can impact the system performance. In particular, the responses of RIS at different frequencies and bandwidths can be different. Failure to predict the frequency capability of RIS in advance can have a serious impact on the system performance. Due to different amplitude-frequency responses, it is desirable to design different phase sets for different frequency points to achieve the target system performance. For example, a RIS supports 28 GHz as its working frequency, but its capability is unknown to the base station. In that case, the RIS may use the 26 GHz frequency electrical adjustment configured by the station, resulting in beam pointing shift or beam shape change that can seriously reduce the system performance. Therefore, accurate determination the frequency capability of RIS can enable the base station to achieve desired system performance.

### Category 3: Time-division Capability

Often times, an RIS structure needs to be dynamically switched to adapt to different channels. For example, in high frequency bands, the channel state information changes more frequently, which imposes more stringent requirements on the time-division capability of RIS.

FIG. 4 illustrates an example flowchart 400 of reporting time-division capability in accordance with one or more embodiments of the present technology. The RIS sends, at operation 410, the time-division capability (e.g., the switching speed capability) to the base station. The base station determines, at operation 420, the switching speed according to the channel state information (CSI) and other requirements. The base station can send the actual time switching speed to RIS at operation 430. The base station and the RIS then synchronize their respective designs at operation 440.

Informing the base station of the RIS's time-division capability can enable the base station to determine the time-division granularity supported by the RIS so as to effectively determine the timing and frequency of the signaling interaction. For example, after the base station obtains the RIS time switching speed and other capabilities, the base station can determine the timing and phase sets of RIS according to the RIS time switching speed and other capabilities. The base station can make full use of the time switching capability of the RIS to adapt to the time-varying channels, thereby avoiding the situation where the base station's transmitting phase set speed exceeds the RIS time switching speed and ensure the synchronization of the base station and the RIS.

### Category 4: Phase Modulation Capability

The phase modulation capability of RIS is related to its hardware structure. The achievable phase modulation capability includes N-bit (N=1, 2, . . . ) quantized phase modulation and continuous phase modulation. For N-bit phase quantization, the phase difference of the RIS element can be expressed as

$$Δφ = \frac{2 π}{{2}^{N}} .$$

Taking 1-bit RIS as an example, the phase of the RIS element includes two cases: 0° and 180°.

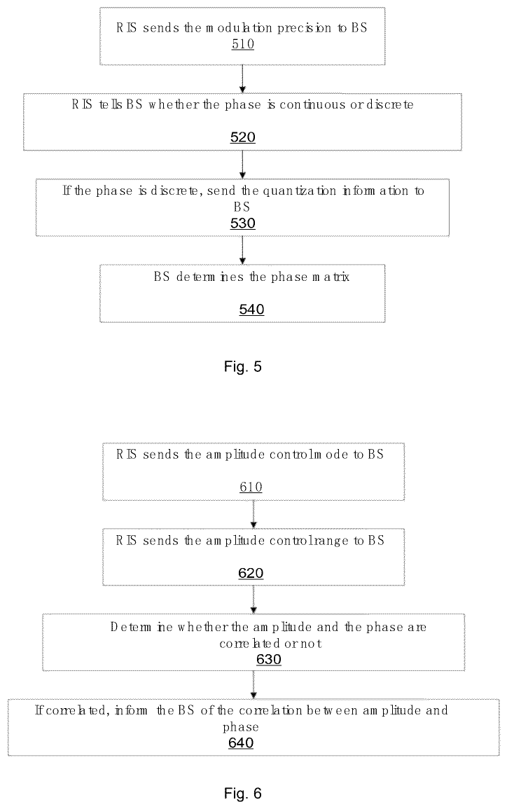

The RIS needs to inform the base station of its phase modulation capability, such as the precision of the phase modulation and/or the number of bits. FIG. 5 illustrates an example flowchart of reporting phase modulation capability in accordance with one or more embodiments of the present technology. At operation 510, the RIS sends the phase modulation precision to the base station. The RIS can also inform the base station at operation 520 whether the phase is continuous or discrete. If the phase is discrete, the RIS can transmit the quantization information to the base station at operation 530. The base station determines the phase matrix at operation 540. Given RIS phase modulation capability, the base station can combine the RIS frequency capability to design different phase sets at different frequency points to realize phase control at the corresponding frequency point.

### Category 5: Amplitude Modulation Capability

Different types of RIS have different amplitude modulation capabilities. As discussed above, the RIS structures can be classified based on the respective energy consumption. For example, an active RIS has the ability to amplify the signal while a passive RIS cannot amplify the amplitude. The amplitude modulation ability of a passive RIS can include two types: constant amplitude and reduced amplitude. Assuming that the ratio of the amplitude of the signal passing through the RIS element to the amplitude of the signal incident on the RIS element is A, the assumption of reducing the amplitude (A<1) is closer to the actual performance of the RIS device. The reduced-amplitude RIS includes a phase-dependent amplitude modulation model and a phase-independent amplitude modulation model. The phase-dependent amplitude modulation capability means that the amplitude and phase of the RIS element satisfy a certain constraint relationship, while the phase-independent amplitude modulation capability means that the amplitude and phase of the RIS element are independent. The active RIS, on the other hand, can achieve an amplitude modulation ratio that is A>1.

The exchange of the amplitude modulation capability enables the proper correlation of the phase and amplitude information. The RIS can report its amplitude modulation capability, including but not limited to the ratio of the amplitude of the signal after passing through the RIS element to the amplitude of the signal incident to the RIS element, the ratio range, and/or whether the amplitude and phase are correlated. If the amplitude and phase are correlated, the RIS can also inform the base station of the correlation between the amplitude and the phase. FIG. 6 illustrates an example flowchart of reporting amplitude modulation capability in accordance with one or more embodiments of the present technology. The RIS can send the amplitude control mode to the base station at operation 610. At operation 620, the RIS also sends the amplitude control range to the base station. The RIS can determine whether the amplitude and the phase are correlated at operation 630. If they are correlated, the RIS can inform the base station of the correlation at operation 640.

### Category 6: Precoding Capability

The precoding capability of RIS includes at least one of precoding granularity, supported precoding model(s), codebook and quantization, RIS grouping precoding capability, and/or capability to support pilot, data, control, etc. using different precoding.

The granularity of precoding can be determined according to the statistical channel characteristics, including frequency selection level, angle spread, user distribution, frequency selective fading and/or spatial selective fading. In the case of high-frequency bands, the frequency domain channel changes rapidly and small-granularity precoding becomes for suitable. Small-granularity precoding is desired for large-angle expansion, scattered user distribution, and/or frequency-domain selective fading and spatial selective fading.

The supported precoding models can include Discrete Fourier Transform (DFT) precoding, Hankel precoding, Kroneck precoding, Gaussian precoding, Bessel precoding, gradient descent precoding, beam focus precoding, lens precoding, chirp precoding, Orbital Angular Momentum (OAM) precoding, etc. The selection basis of the precoding model can include UE position/distribution, distance, target signal shape (wide beam, narrow beam, etc.), target beam shape, and the like. To realize a narrow beam in the far-field, DFT precoding, Kroneck precoding, or gradient descent precoding can be selected. To realize a wide beam in the far-field, Hankel precoding, Gaussian precoding, or chirp precoding can be selected. To realize a narrow beam in the near-field, beam focusing precoding or lens precoding can be selected. To achieve a wide beam in the near-field, chirp precoding or Hankel precoding can be selected. To achieve orbital angular momentum beams, OAM precoding can be selected. The RIS or the base station can select an appropriate precoding model according to user requirements, channel conditions, and so on.

The selection of the RIS codebook is related to the predetermined codebook design. Specific codebook(s) can be implemented based on the limitation of the quantization of the RIS element. The base station or the RIS can select the codebook from the preset codebook(s). The RIS can inform the base station of the codebook(s) it supports, and the base station or RIS can determine the appropriate codebook to match different transmission targets.

RIS element grouping precoding capability is an effective means for the RIS to support multi-user transmissions. Through RIS element grouping precoding, multiple users can be supported at the same time and at the same frequency, multiple directional beams or multiple focused beams can be realized, and the device cost can be effectively reduced. The granularity of RIS element grouping precoding is determined by factors such as the number of users, the distribution of user angles, channel state information, cost constraints, etc. If the number of users is large, the number of RIS element groups can be increased. If the user angle distribution is concentrated or the channel state information changes rapidly, the number of RIS element groups can be reduced.

In addition, capability information regarding whether the RIS can support pilot, data, control using different precoding methods can be reported to the base station to determine the appropriate precoding scheme at different stages. The exchange of the RIS precoding capability can help the base station determine the selection range of the RIS phase shift matrix and the design criteria of the phase shift matrix, simplify the design process of the RIS phase shift matrix, and convert the high-dimensional optimization problem into a low-complexity selection or parameter design problem. The design of sub-array precoding can further support the generation of multiple beams and reduce control complexity.

### Category 7: Baseb and Measurement Capability

When the RIS has baseband measurement capability, the original concatenated channel estimation can be divided into segmented channel estimation, and the complexity of the channel estimation can be significantly reduced. Such capability information (e.g., baseband measurement, the number of ports, and/or array element location information) can be sent to the base station to avoid the difficulty of channel estimation caused by the limited number of antennas.

On the other hand, if the RIS does not have the baseband measurement capability, the base station can be notified of the corresponding information to have the proper channel estimation design and beamforming design.

### Category 8: Transmission and Reflection Capability

Different types of RIS can have different transmission and reflection capabilities. The specific transmission and reflection capabilities include whether there is energy loss in RIS, whether the transmission and reflection of RIS are controllable, the range of transmittance and reflectance that RIS can achieve, the constraint relationship between the transmission phase and the reflection phase, and/or the constraint relationship between transmission amplitude and reflection amplitude. Such information can be important for the base station to determine the properties of the RIS in conjunction with the type (e.g., only reflective, only transmitting, or both reflective and transmitting).

The acquisition of the transmission and reflection capability of RIS helps the base station to determine the reflection and reflection capabilities supported by the RIS, determine its capability limits and constraints, and reasonably design the reflection and transmission beams to better support multi-user transmission.

### RIS Network Configuration Information

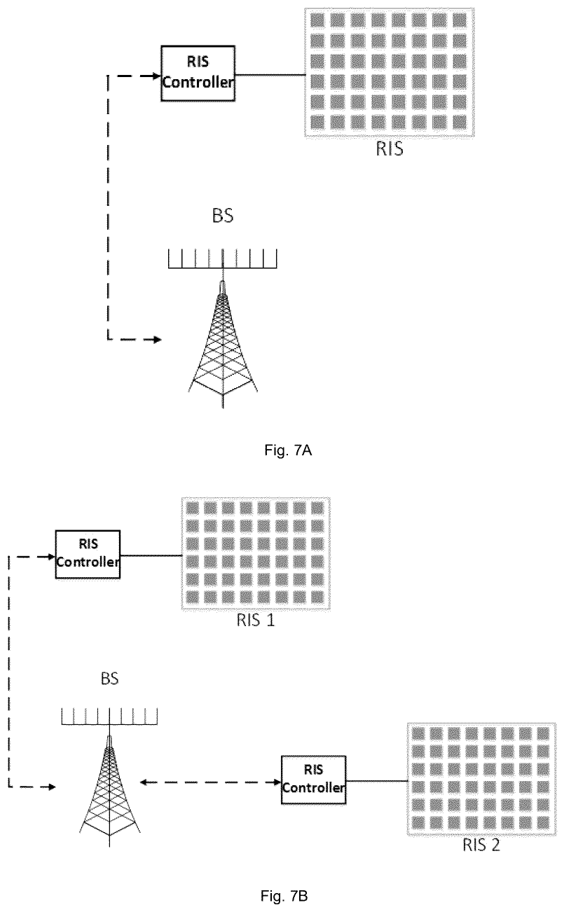

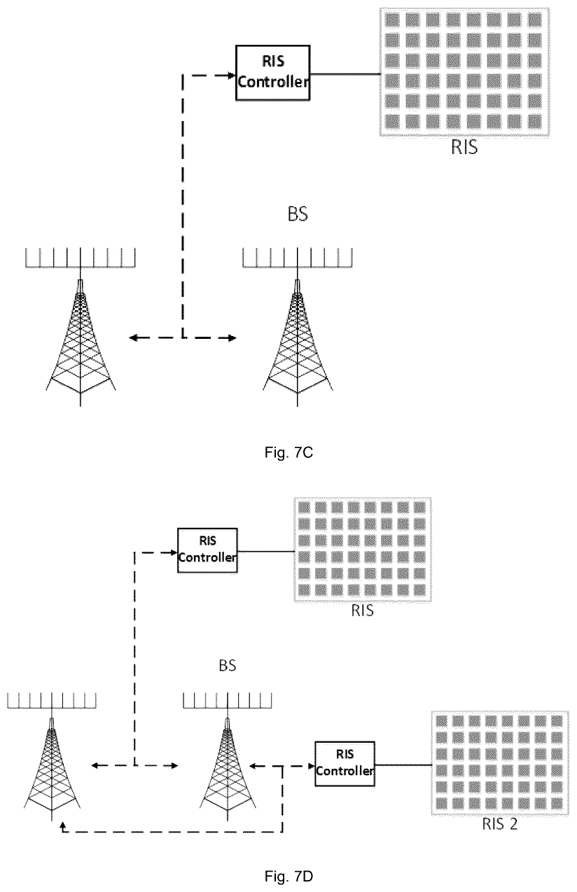

In a communication system, one RIS structure can be controlled by one or more base stations. One base station can control one or more RIS structures. FIGS. 7A-D illustrate different network configurations of RIS structure(s) and base station(s) in accordance with one or more embodiments of the present technology. It is desirable for the base station(s) and the RIS to exchange network configuration information and/or control information.

FIG. 7A illustrates an example of one RIS structure in communication with a single base station in accordance with one or more embodiments of the present technology. The RIS informs the base station of its identifier (e.g., RIS ID). The RIS also transmits the type information and capability information to the base station when it gains access to the network so that the base station can determine the corresponding control information for subsequent transmissions.

FIG. 7B illustrates an example of multiple RIS structures in communication with a single base station in accordance with one or more embodiments of the present technology. In this example, each RIS informs the base station of its RIS ID, type information, and capability information when accessing the system. Upon receiving the information from the multiple RIS structures, the base station can design a multi-RIS control strategy and determine the control information accordingly. Furthermore, synchronous design of multiple RIS is important to ensure the efficient work of the RIS structures.

FIG. 7C illustrates an example of multiple base stations in communication with a single RIS structure in accordance with one or more embodiments of the present technology. In this example, the RIS can broadcast its RIS ID, the type information, and capability information to the base stations that it is in communication with. Upon receiving the broadcasted information, the base stations can determine the corresponding control information. Synchronization among the multiple base stations to avoid the performance loss is important in such scenarios.

FIG. 7D illustrates an example of multiple base stations in communication with multiple RIS structures in accordance with one or more embodiments of the present technology. In this example, each RIS can broadcast its respective RIS ID, type information, and capability information to the base stations that it is in communication with. Upon receiving the broadcasted information, the base stations can determine the corresponding control information. Synchronization among the base stations, as wells synchronization of the RIS structures are important in such scenarios. For each RIS, the base stations that control the RIS need to exchange signaling to determine the control channel so as to realize the multi-BS cooperative controlling of RIS.

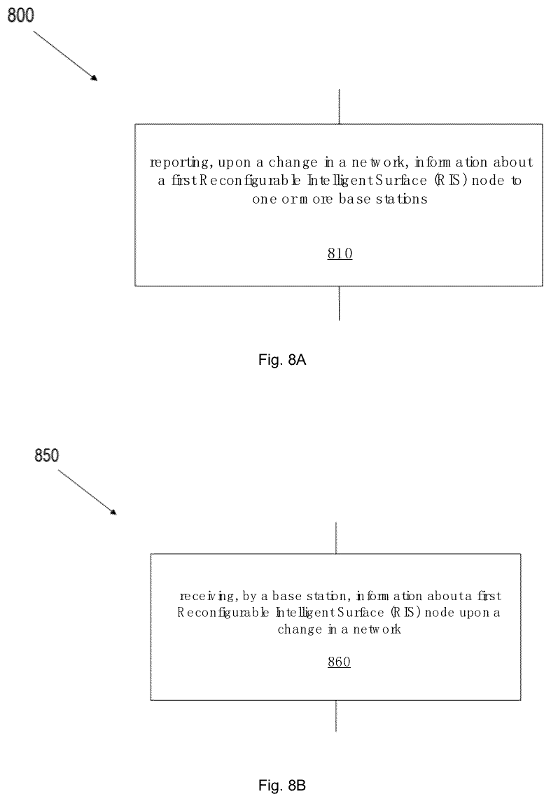

FIG. 8A is a flowchart representation of a method 800 for wireless communication in accordance with one or more embodiments of the present technology. The method 800 includes, at operation 810, reporting, upon a change in a network, information about a first Reconfigurable Intelligent Surface (RIS) node to one or more base stations. A reconfigurable intelligent surface comprises a material having an electromagnetic property that is configurable. In this disclosure, a RIS, a RIS node, and a RIS structure are used interchangeably to refer to an RIS network component.

The change in the network includes various scenarios, including but not limited to: an initial attachment of the first RIS node to the network, a configuration update of the first RIS node, or an update of at least one base station, such as an addition of a base station or a deletion of a base station from the multiple base stations that are in communication with the first RIS.

In some embodiments, the information is broadcast from the first RIS node, such as shown in FIG. 7B and/or FIG. 7D. In some embodiments, the information can be transmitted by the first RIS node at a Radio Resource Control (RRC) layer in a way similar to User Equipment (UE) capability reporting (e.g., as shown in FIG. 7A and/or FIG. 7C).

In some embodiments, the first RIS transmits its RIS ID to the base station(s). It then transmits the information to the base station(s) before receiving further control information from the base station(s). The information about the first RIS node comprises at least one of: type information of the first RIS node or capability information of the first RIS node. The type information comprises at least one of: a reflective RIS type, a transmitting RIS type, an RIS-based transmitter type, a simultaneous transmitting and reflecting RIS type, or a back-to-back RIS type (e.g., as shown in FIGS. 1A-E).

In some embodiments, the capability information comprises at least one of: performance capability information, frequency capability information, time-division capability information, phase modulation capability information, amplitude modulation capability information, precoding capability information, measurement capability information, or transmission and reflection capability information. In some embodiments, the performance capability information comprises at least one of: topology information of the first RIS node, a type and/or a number of RIS elements of the first RIS node, a sensing ability of the first RIS node, energy transmission information of the first RIS node, impedance information of the first RIS node, or locational information of the first RIS node (e.g., as shown in FIGS. 2A-B). The frequency capability information comprises a frequency and/or a bandwidth supported by the first RIS node. In some embodiments, the time-division capability information comprises a response time or a time switching speed of the first RIS node. In some embodiments, the phase modulation capability information comprises a precision of phase modulation and/or a number of bits supported by the first RIS node. In some embodiments, the amplitude modulation capability information comprises at least a ratio of signal amplitude, a ratio range, or a correlation between an amplitude and a phase supported by the first RIS node. In some embodiments, the precoding capability information comprises at least a precoding granularity, a precoding model supported by the first RIS node, a codebook and/or quantization, or a grouping of precoding capability. In some embodiments, the measurement capability information comprises at least a number of ports and/or location information of RIS elements of the first RIS node. In some embodiments, the transmission and reflection capability information comprises at least an energy loss in the first RIS, a controllability of transmission and reflection, a range of transmittance and/or reflectance, an association between a transmission phase and a reflection phase, or an association between a transmission amplitude and a reflection amplitude.

In some embodiments, the method includes receiving, by the first RIS node, control information from the one or more base stations. The control information indicates that the one or more base stations are in communication with a plurality of RIS nodes that includes the first RIS node. In some embodiments, the control information from the base station to the first RIS node comprises at least information about a control channel, a channel measurement, or a precoding scheme. The method further includes transmitting, by the first RIS node, information to the one or more base stations to enable the one or more base stations to coordinate the plurality of RIS nodes.

FIG. 8B is a flowchart representation of a method for wireless communication in accordance with one or more embodiments of the present technology. The method 850 includes, at operation 860, receiving, by a base station, information about a first Reconfigurable Intelligent Surface (RIS) node upon a change in a network. A reconfigurable intelligent surface comprises a material having an electromagnetic property that is configurable.

Referring back to FIG. 7B, in some embodiments, the base station is in communication with a plurality of RIS nodes that includes the first RIS node. The base station can determine the control information (e.g., the network configuration information) based on the reported type and capability information from the plurality of RIS nodes. The method includes transmitting, by the base station, control information to the first RIS node based on information from the plurality of RIS nodes. In some embodiments, the method includes re-evaluating the control information upon a change to the plurality of RIS nodes and transmitting the re-evaluated control information to RIS nodes that remain in communication with the base station. Here, a change to the plurality of the RIS nodes includes an addition of an RIS node, a deletion of an RIS node, or any configuration changes performed on an RIS node. For example, if the capability information of an RIS node is adjusted or a new RIS gains access to the network, the adjusted RIS or the newly added RIS needs to inform the base station of its RIS ID and relevant information. The base station also needs to adjust control information to realize the dynamic exchange of RIS information.

In some embodiments, the base station(s) can collect RIS type information from one or more RIS nodes and determine control information or network configuration information based on the type information first. The base station(s) then receives the capability information from the RIS node(s). The network configuration information can be optionally updated based on the RIS capability information.

In some embodiments, the base station(s) can collect RIS capability information from one or more RIS nodes and determine control information or network configuration information based on the capability information first. The base station(s) then receives the type information from the RIS node(s). The network configuration information can be optionally updated based on the RIS type information.

In some embodiments, the base station(s) can determine the network configuration information first (e.g., based on preconfigured information of the RIS node(s) or a predefined set of rules). The base station(s) then receive the RIS type and/or capability information from the RIS node(s). The network configuration information can be optionally updated based on the type and/or capability information.

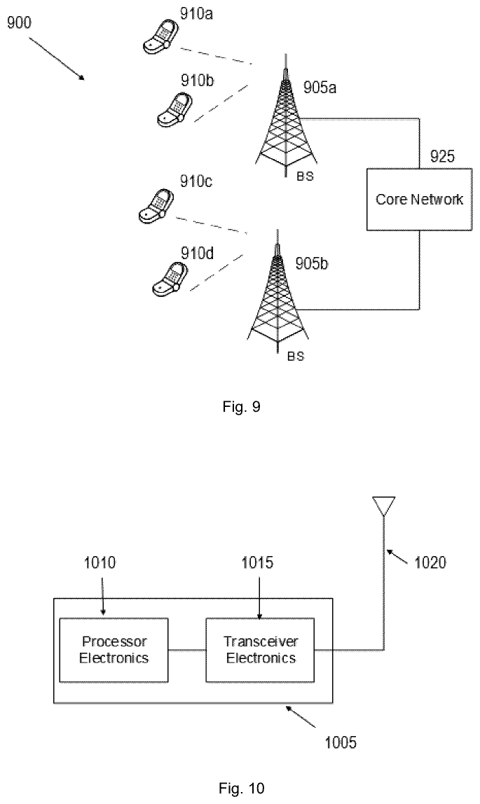

FIG. 9 shows an example of a wireless communication system 900 where techniques in accordance with one or more embodiments of the present technology can be applied. A wireless communication system 900 can include one or more base stations (BSs) 905a, 905b, one or more wireless devices (or ULs) 910a, 910b, 910c, 910d, and a core network 925. A base station 905a, 905b can provide wireless service to user devices 910a, 910b, 910c and 910d in one or more wireless sectors. In some implementations, a base station 905a, 905b includes directional antennas to produce two or more directional beams to provide wireless coverage in different sectors. The core network 925 can communicate with one or more base stations 905a, 905b. The core network 925 provides connectivity with other wireless communication systems and wired communication systems. The core network may include one or more service subscription databases to store information related to the subscribed user devices 910a, 910b, 910c, and 910d. A first base station 905a can provide wireless service based on a first radio access technology, whereas a second base station 905b can provide wireless service based on a second radio access technology. The base stations 905a and 905b may be co-located or may be separately installed in the field according to the deployment scenario. The user devices 910a, 910b, 910c, and 910d can support multiple different radio access technologies. The techniques and embodiments described in the present document may be implemented by the base stations of wireless devices described in the present document.

FIG. 10 is a block diagram representation of a portion of a radio station in accordance with one or more embodiments of the present technology can be applied. A radio station 1005 such as a network node, a base station, or a wireless device (or a user device, UE) can include processor electronics 1010 such as a microprocessor that implements one or more of the wireless techniques presented in this document. The radio station 1005 can include transceiver electronics 1015 to send and/or receive wireless signals over one or more communication interfaces such as antenna 1020. The radio station 1005 can include other communication interfaces for transmitting and receiving data. Radio station 1005 can include one or more memories (not explicitly shown) configured to store information such as data and/or instructions. In some implementations, the processor electronics 1010 can include at least a portion of the transceiver electronics 1015. In some embodiments, at least some of the disclosed techniques, modules or functions are implemented using the radio station 1005. In some embodiments, the radio station 1005 may be configured to perform the methods described herein.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this disclosure contains many specifics, these should not be construed as limitations on the scope of any invention or of what may be claimed, but rather as descriptions of features that may be specific to particular embodiments of particular inventions. Certain features that are described in this disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this disclosure should not be understood as requiring such separation in all embodiments.

Only a few implementations and examples are described, and other implementations, enhancements and variations can be made based on what is described and illustrated in this disclosure.

1. A method for wireless communication, comprising:
reporting, upon a change in a network, information about a first Reconfigurable Intelligent Surface (RIS) node to one or more base stations, wherein a reconfigurable intelligent surface comprises a material having an electromagnetic property that is configurable.

2. The method of claim 1, further comprising:
receiving, by the first RIS node, control information from the one or more base stations, wherein the control information indicates that the one or more base stations are in communication with a plurality of RIS nodes that includes the first RIS node; and
transmitting, by the first RIS node, information to the one or more base stations to enable the one or more base stations to coordinate the plurality of RIS nodes.

3. A method for wireless communication, comprising:
receiving, by a base station, information about a first Reconfigurable Intelligent Surface (RIS) node upon a change in a network, wherein a reconfigurable intelligent surface comprises a material having an electromagnetic property that is configurable.

4. The method of claim 3, wherein the base station is in communication with a plurality of RIS nodes that includes the first RIS node, the method comprising:
transmitting, by the base station, control information to the first RIS node based on information from the plurality of RIS nodes.

5. The method of claim 4, further comprising:
re-evaluating the control information upon a change to the plurality of RIS nodes; and
transmitting the re-evaluated control information to RIS nodes that remain in communication with the base station.

6. The method of claim 3, wherein the change in the network comprises at least one of:
an initial attachment of the first RIS node to the network;
a configuration update of the first RIS node; or
an update of at least one base station, comprising an addition of a base station or a deletion of a base station.

7. The method of claim 3, wherein the information is broadcast from the first RIS node.

8. The method of claim 3, wherein the information is transmitted by the first RIS node at a Radio Resource Control (RRC) layer.

9. The method of claim 3, wherein the information about the first RIS node comprises at least one of: type information of the first RIS node or capability information of the first RIS node.

10. The method of claim 9, wherein the type information comprises at least one of:
a reflective RIS type,
a transmitting RIS type,
an RIS-based transmitter type,
a simultaneous transmitting and reflecting RIS type, or
a back-to-back RIS type.

11. The method of claim 9, wherein the capability information comprises at least one of:
performance capability information,
frequency capability information,
time-division capability information,
phase modulation capability information,
amplitude modulation capability information,
precoding capability information,
measurement capability information, or
transmission and reflection capability information.

12. The method of claim 11, wherein the performance capability information comprises at least one of: topology information of the first RIS node, a type and/or a number of RIS elements of the first RIS node, a sensing ability of the first RIS node, energy transmission information of the first RIS node, impedance information of the first RIS node, or locational information of the first RIS node.

13. The method of claim 11, wherein the frequency capability information comprises a frequency and/or a bandwidth supported by the first RIS node.

14. The method of claim 11, wherein the time-division capability information comprises a response time or a switching speed of the first RIS node.

15. The method of claim 11, wherein the phase modulation capability information comprises a precision of phase modulation and/or a number of bits supported by the first RIS node.

16. The method of claim 11, wherein the amplitude modulation capability information comprises at least a ratio of signal amplitude, a size range, or a correlation between an amplitude and a phase supported by the first RIS node.

17. The method of claim 11, wherein the precoding capability information comprises at least a precoding granularity, a precoding model supported by the first RIS node, a codebook and/or quantization, or a grouping of precoding capability.

18. The method of claim 11, wherein the measurement capability information comprises at least a number of ports and/or location information of RIS elements of the first RIS node;
or, wherein the transmission and reflection capability information comprises at least an energy loss in the first RIS, a controllability of transmission and reflection, a range of transmittance and/or reflectance, an association between a transmission phase and a reflection phase, or an association between a transmission amplitude and a reflection amplitude.

19. (canceled)

20. The method of any of claim 4, wherein the control information to the first RIS node comprises at least information about a control channel, a channel measurement, or a precoding scheme.

21. A communication apparatus, comprising a processor configured to implement a method recited in claim 1.

22. (canceled)
